(19) United States
(12) Patent Application Publication
(10) Pub. No.: US 2023/0038253 A1
(43) Pub. Date: Feb. 9, 2023

(54) METHOD FOR RECORDING HOLOGRAPHIC OPTICAL ELEMENT FOR HEAD-UP DISPLAY

(71) Applicant: Korea Electronics Technology Institute, Seonganm-si (KR)

(72) Inventors: Ji Soo HONG, Seoul (KR); Sung Hee HONG, Seoul (KR); Young Min KIM, Seoul (KR)

(73) Assignee: Korea Electronics Technology Institute, Seonganm-si (KR)

(21) Appl. No.: 17/781,474

(22) PCT Filed: Dec. 6, 2019
(86) PCT No.: PCT/KR2019/017166

§ 371 Date: Jun. 1, 2022

(30) Foreign Application Priority Data
Dec. 6, 2019 (KR) 10-2019-0161228

(51) Int. Cl. G02B 27/01; G02B 27/30

(52) U.S. Cl. CPC G02B 27/0103; G02B 27/30; G02B 2027/0105

(57) ABSTRACT

Provided is a method in which, when configuring an HUD that produces a holographic image at a distance using a holographic optical element (HOE), an HOE capable of correcting aberrations generated by a projection optical system is manufactured and used to improve the quality of an HUD image. A method for manufacturing an HOE for HUD according to an embodiment of the present invention comprises the steps of: measuring aberrations generated by an optical system that projects an image of a display device; recording the measured aberrations in a master HOE; reproducing an aberrated wavefront of the optical system by playing the master HOE on a display plane on which the image of the display device is expressed; and causing an interference of the reproduced aberrated wavefront and a spherical wavefront irradiated from the HUD image plane on which the image of the display device is created, and recording the interference in the HOE. Accordingly, when configuring the HUD producing an image at a distance using the HOE, the quality of the HUD image can be improved by measuring aberrations in the projection optical system, creating a master HOE that reproduces the measured aberrations, and manufacturing a HOE that corrects the aberrations, and correcting aberrations generated in the projection optical system.

### TECHNICAL FIELD

The present disclosure relates to holographic technology, and more particularly, to a method for fabricating a holographic optical element used in a head up display (HUD), and an HUD system applying the same.

### BACKGROUND ART

An HUD is electronic equipment for vehicles which is developed and commercialized to enhance safety and convenience of drivers, and displays an image indicating a vehicle state or traffic information on a frontal space of a vehicle.

In order to maximize user's convenience, an image produced by the HUD is required to be displayed at a long distance, and accordingly, there is a need for solving this problem.

In a process of solving this problem, there may be a problem that quality of the image is degraded, and accordingly, there is a need for a method for guaranteeing an image of high quality on an HUD image plane at a long distance.

### DISCLOSURE

### Technical Problem

The present disclosure has been developed in order to address the above-discussed deficiencies of the prior art, and an object of the present disclosure is to provide a method for fabricating a holographic optical element (HOE) capable of compensating for an aberration caused by a projection optical system when an HUD for focusing an image at a long distance by using an HOE is configured, and for enhancing quality of an HUD image through the HOE.

### Technical Solution

According to an embodiment of the present disclosure to achieve the above-described object, a method for fabricating a holographic optical element (HOE) for an HUD, the method including the steps of: measuring an aberration which is caused by an optical system for projecting an image of a display device; recording the measured aberration on a master HOE; reproducing an aberrated wavefront of the optical system, by reproducing the master HOE on a display plane on which the image of the display device is expressed; and causing the reproduced aberrated wavefront and a spherical wave emitted from an HUD image plane on which the image of the display device is focused to interfere with each other, and recording the wavefront on the HOE.

The step of measuring may include measuring the aberration occurring when a point source at a center of the display device passes through the optical system.

The step of measuring may include: a first generation step of generating a collimated beam; a second generation step of generating an aberrated wavefront of the optical system by using the generated collimated beam; a third generation step of generating a spherical wave which propagates on the display plane by using the collimated beam; causing the generated aberrated wavefront and the generated spherical wave to interfere with the generated collimated beam, and recording the wavefront; and measuring the aberration on the display plane from the recorded wavefront.

The second generation step may include generating the aberrated wavefront by focusing the generated collimated beam on a center of a display device plane where the display device is to be positioned, and then allowing the collimated beam to pass through the optical system.

The third generation step may include generating the spherical wave by focusing the collimated beam on a center of the display plane with a lens.

The step of measuring may include measuring the aberration on the display plane by obtaining only a complex field which is effective in an angular spectrum domain from an image picked-up wavefront, and computatively propagating to the display plane.

The step of recording may include recording the aberration measured by a holographic wavefront printer on the master HOE.

The HOE may compensate for the aberration caused by the optical system.

The HOE may reflect the aberrated wavefront generated by the optical system, and may generate a spherical wave toward an HUD image plane.

According to another aspect of the present disclosure, there is provided a head up display (HUD) including: a display device configured to express an image; an optical system configured to project an image of the display device; and a holographic optical element (HOE) configured to focus the image of the display device projected by the optical system on an image plane at a long distance, wherein the HOE is fabricated by measuring an aberration which is caused by an optical system, recording the measured aberration on a master HOE, reproducing an aberrated wavefront of the optical system by reproducing the master HOE on a display plane on which the image of the display device is expressed, and causing the reproduced aberrated wavefront and a spherical wave emitted from an image plane to interfere with each other, and recording the wavefront.

According to still another aspect of the present disclosure, there is provided a method for fabricating an HOE for an HUD, the method including the steps of: reproducing an aberrated wavefront of an optical system, by reproducing a master HOE on a display plane on which an image of a display device is expressed, an aberration caused by the optical system for projecting the image of the display device being recorded on the master HOE; and causing the reproduced aberrated wavefront and a spherical wave emitted from a head up display (HUD) image plane on which the image of the display device is focused to interfere with each other, and recording the wavefront on the HOE.

According to yet another aspect of the present disclosure, there is provided an HOE fabrication system for an HUD, the system including: a master holographic optical element (HOE) on which an aberration caused by an optical system for projecting an image of a display device is recorded; and a HOE configured to cause an aberrated wavefront of the optical system and a spherical wave to interfere with each other, and to record, the aberrated wavefront being reproduced by the master HOE which is reproduced on a display plane on which the image of the display device is expressed, the spherical wave being emitted from a head up display (HUD) image plane on which the image of the display device is focused.

### Advantageous Effects

According to embodiments of the present disclosure as described above, when an HUD for focusing an image at a long distance by using an HOE is configured, by fabricating an HOE which measures an aberration of a projection optical system, makes a master HOE for reproducing the measured aberration, and compensates for the aberration through the master HOE, an aberration caused by the projection optical system can be compensated for and quality of an HUD image can be enhanced.

### DESCRIPTION OF DRAWINGS

FIG. 1 is a view illustrating a method of recording on an HOE for an HUD;

FIG. 2 is a view illustrating a method of configuring an HUD by using an HOE;

FIG. 3 is a view illustrating a method of configuring an HUD by using a projection optical system;

FIG. 4 is a view illustrating an aberration measurement method of a projection optical system;

FIG. 5 is a view illustrating a method of recording on an HOE for an HUD using a measured aberration; and

FIG. 6 is a view illustrating a display method of an HUD image having an aberration compensated for.

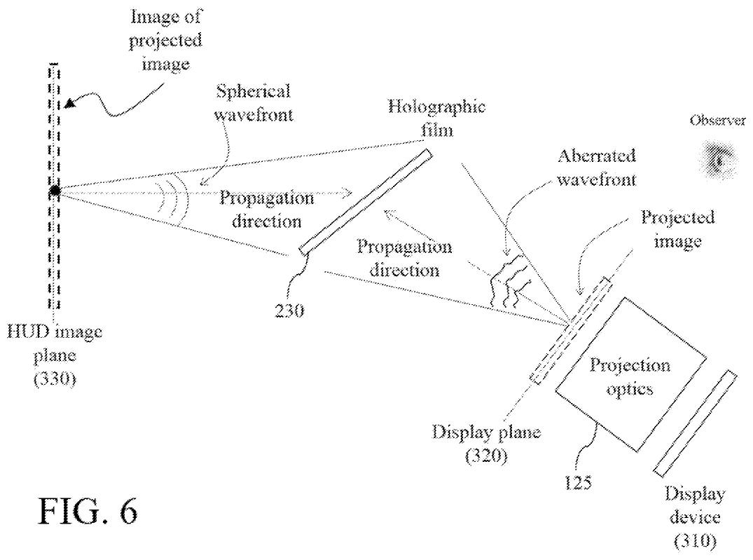

### BEST MODE

Hereinafter, the present disclosure will be described in more detail with reference to the drawings.

A method for implementing a head up display (HUD) to display an image at a long distance may use a reflective holographic optical element (HOE) performing a lens function as an optical combiner.

By dosing so, an image displayed on the display may be reflected by the HOE, and the image of the display may be focused at a long distance by the lens function of the HOE, such that the HUD is implemented in the form of combination of the long-distance image of the display with an outside landscape.

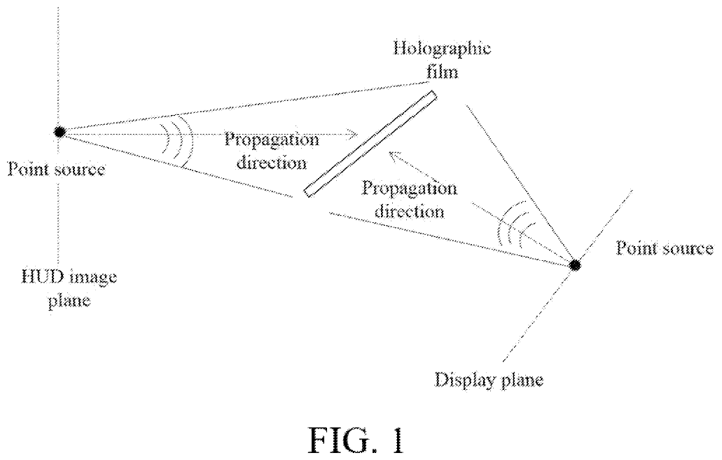

A method of recording on the HOE for this purpose is recording on a holographic film in a method of analogue holography with a configuration shown in FIG. 1.

When an HUD is configured, a position where an image is displayed on a display may be referred to as a display plane, and a position at a long distance where the image is to be focused may be referred to as an HUD image plane. In this case, point sources which interfere with each other are made at a center of the display plane and a center of the HUD image plane, respectively, by using one laser source, and spherical waves emitted from the point sources are caused to interfere with each other on a holographic film, thereby being recorded on a reflective HOE having a lens function.

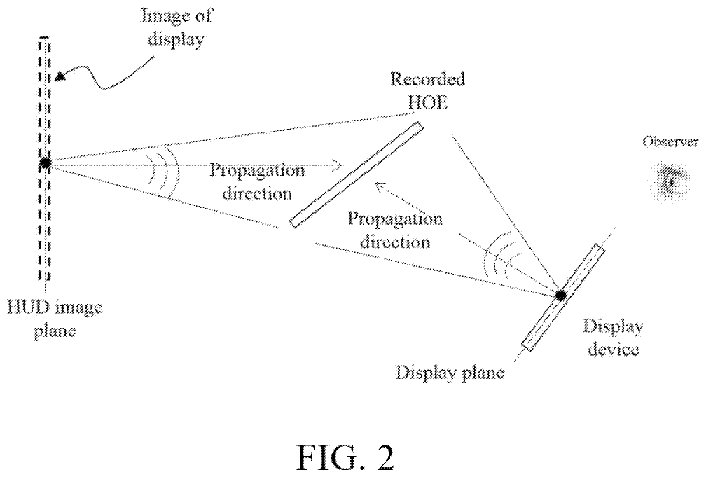

FIG. 2 shows a method of configuring an HUD by using an HOE. When a display device is positioned on a plane that is assumed as a display plane when the HOE of FIG. 1 is recorded, respective pixels of the display device focus an image on an HUD image plane due to the lens function of the HOE, and, when an observer looks the HUD image plane, an image of the display is focused on the HUD image plane at a long distance, so that the observer can view the image.

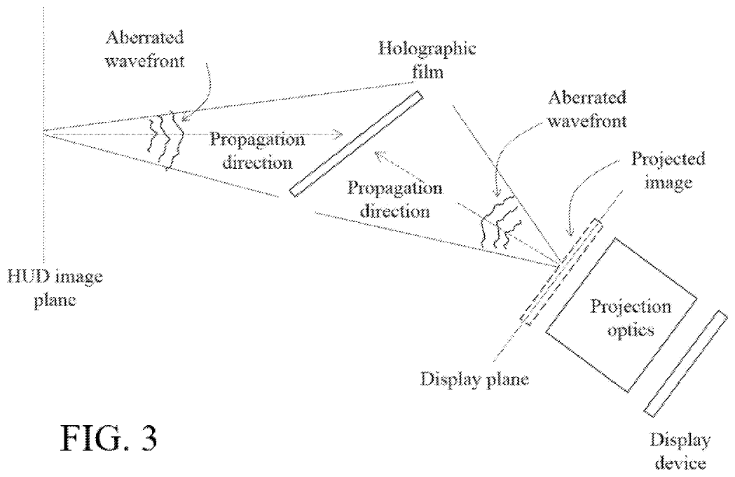

However, in practice, it is difficult to provide a display device of a desired size and resolution on the display plane, and accordingly, as shown in FIG. 3, an image of a display device is made to pass through a separate projection optical system (projection optics), thereby forming a projection image having a desired size and resolution on the display plane.

In this case, there may be an aberration caused by the projection optical system, and the respective pixels of the display device make an aberrated wavefront on the display plane. This may degrade quality of an image on the HUD image plane which is at a long distance when the wavefront is reflected by the HOE.

Hereinafter, an HOE recording method which measures an aberration of a projection optical system, makes a master HOE for reproducing the aberration, and compensates for the aberration through the master HOE, in order to record on a HOE for compensating for an aberration caused by the projection optical system when an HUD for focusing an image at a long distance by using the HOE is configured, will be suggested.

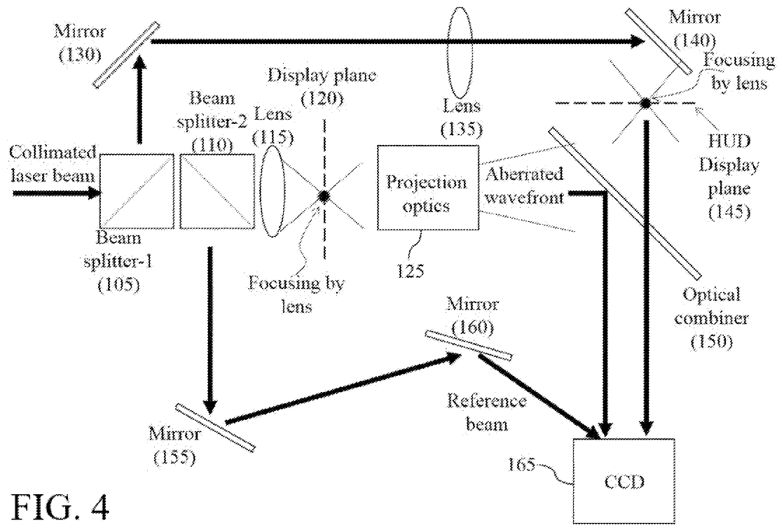

FIG. 4 shows a method for measuring an aberration caused by a projection optical system.

On the assumption that NA of the projection optical system 125 is not great and an aberration is spatially invariant, an aberration occurring when a point source at a center of a display device passes through the projection optical system 125 may represent a total aberration of the projection optical system 125.

Accordingly, when an HUD is configured as shown in FIG. 3 and a plane where the display device is to be positioned is referred to as a display device plane 120, a point source may be positioned at a center of the display device plane 120 and may be regarded as a guide star.

This guide star passes through the projection optical system 125, thereby generating an aberrated wavefront, and an aberration may be measured by using a guide start hologram having the aberrated wavefront recorded thereon.

To achieve this, a collimated laser beam is generated by a laser module (not shown), and passes through two beam splitters 105, 110, thereby being divided into three light paths.

First, in the middle of passing through the beam splitters 105, 110 and progressing, the collimated laser beam is focused on the display device plane 120 through a lens 115, and is used as a point source for the projection optical system 125, and is made to pass through the projection optical system 125, thereby generating an aberrated wavefront.

Through an upper end light path, the collimated laser beam which is divided at the beam splitter-1 105 and is reflected through a mirror 130 is focused by a lens 135 on an HUD display plane 145, that is, a plane on which the projection optical system 125 images the display device, and spherical waves resulting therefrom may be recorded and a guide star hologram obtained thereafter may be used as a reference for propagating on the HUD display plane.

Accordingly, the upper end light path and a middle light path are combined through an optical combiner 150, and allow a beam to enter a CCD 160. In order to record the combined wavefront as a hologram, the collimated laser beam is made to enter as a reference beam by using mirrors 155, 160 through a lower end light path, and a hologram regarding an aberrated wavefront from the projection optical system 125 and a spherical wave from the HUD display plane 145 may be recorded through interference.

Since the wavefront recorded as described above is an off-axis hologram that is recorded in an amplitude type, only a complex field which is effective in an angular spectrum domain may be obtained, and the complex field may be computatively propagated to the HUD display plane 145, such that an aberration on the HUD display plane 145 is measured.

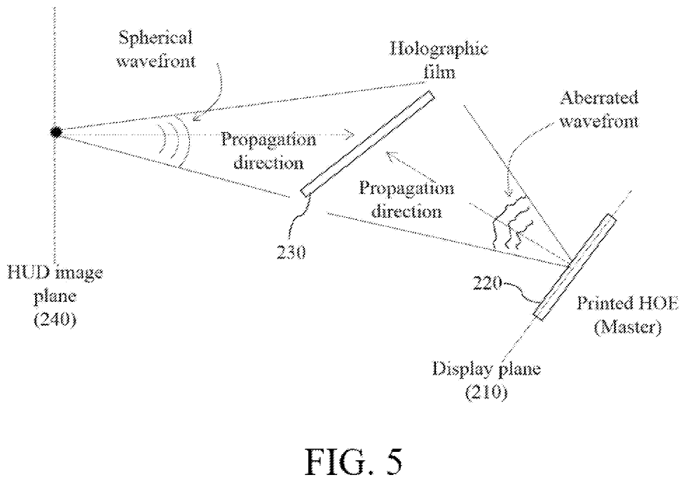

FIG. 5 shows a recording method for reflecting an aberration measured as described above on an HOE for an HUD.

When a measured aberration is recorded by a master HOE 220 and this is placed on an HUD display plane 210 and is reproduced, the aberrated wavefront that is generated by the above-described projection optical system 125 may be reproduced as it is.

The aberrated wavefront reproduced as described above and a spherical wave starting from an HUD image plane 240 are made to interfere with each other and are recorded on a holographic film 230, which is a kind of HOE. Accordingly, when an aberrated wavefront enters as incident light, the HOE for the HUD reflecting a spherical wave starting from a position of the HUD image plane 240 may record.

In this case, a method of generating a HOE 220 for recording an aberration may actually fabricate an optical element appropriate to a measured aberration, and may record the aberration by the master HOE 202, or may fabricate through printing by using a holographic wavefront printer.

When the holographic film 230 for the HUD recorded through the method of FIG. 5 is utilized, and when the projection optical system 125 has a display device 310 disposed to image on an HUD image plane 330, an aberrated wavefront caused by the projection optical system 125 is reflected by the holographic film 230 for the HUD, and generates a spherical wave toward the HUD image plane 330, and as a result, a HUD image having an aberration compensated for is viewed by an observer.

Up to now, the holographic optical element recording method for the head-up display has been described in detail with reference to preferred embodiments.

In an embodiment of the present disclosure, an HOE recording method which can enhance quality of an HUD image, by measuring an aberration of a projection optical system, making a master HOE for reproducing the aberration, and compensating for the aberration through the master HOE, in order to record on a HOE for compensating for an aberration caused by the projection optical system when an HUD for focusing an image at a long distance by using the HOE such as a holographic film is configured, and an HUD using the HOE are suggested.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A method for fabricating a holographic optical element (HOE) for an HUD, the method comprising the steps of:
measuring an aberration which is caused by an optical system for projecting an image of a display device;
recording the measured aberration on a master HOE;
reproducing an aberrated wavefront of the optical system, by reproducing the master HOE on a display plane on which the image of the display device is expressed; and
causing the reproduced aberrated wavefront and a spherical wave emitted from an HUD image plane on which the image of the display device is focused to interfere with each other, and recording the wavefront on the HOE.

2. The method of claim 1, wherein the step of measuring comprises measuring the aberration occurring when a point source at a center of the display device passes through the optical system.

3. The method of claim 2, wherein the step of measuring comprises:
a first generation step of generating a collimated beam;
a second generation step of generating an aberrated wavefront of the optical system by using the generated collimated beam;
a third generation step of generating a spherical wave which propagates on the display plane by using the collimated beam;
causing the generated aberrated wavefront and the generated spherical wave to interfere with the generated collimated beam, and recording the wavefront; and
measuring the aberration on the display plane from the recorded wavefront.

4. The method of claim 3, wherein the second generation step comprises generating the aberrated wavefront by focusing the generated collimated beam on a center of a display device plane where the display device is to be positioned, and then allowing the collimated beam to pass through the optical system.

5. The method of claim 3, wherein the third generation step comprises generating the spherical wave by focusing the collimated beam on a center of the display plane with a lens.

6. The method of claim 3, wherein the step of measuring comprises measuring the aberration on the display plane by obtaining only a complex field which is effective in an angular spectrum domain from an image picked-up wavefront, and computatively propagating to the display plane.

7. The method of claim 1, wherein the step of recording comprises recording the aberration measured by a holographic wavefront printer on the master HOE.

8. The method of claim 1, wherein the HOE is configured to compensate for the aberration caused by the optical system.

9. The method of claim 8, wherein the HOE is configured to reflect the aberrated wavefront generated by the optical system, and to generate a spherical wave toward an HUD image plane.

10. A head up display (HUD) comprising:
a display device configured to express an image;
an optical system configured to project an image of the display device; and
a holographic optical element (HOE) configured to focus the image of the display device projected by the optical system on an image plane at a long distance,
wherein the HOE is fabricated by measuring an aberration which is caused by an optical system, recording the measured aberration on a master HOE, reproducing an aberrated wavefront of the optical system by reproducing the master HOE on a display plane on which the image of the display device is expressed, and causing the reproduced aberrated wavefront and a spherical wave emitted from an image plane to interfere with each other, and recording the wavefront.

11. A method for fabricating an HOE for an HUD, the method comprising the steps of:
reproducing an aberrated wavefront of an optical system, by reproducing a master HOE on a display plane on which an image of a display device is expressed, an aberration caused by the optical system for projecting the image of the display device being recorded on the master HOE; and
causing the reproduced aberrated wavefront and a spherical wave emitted from a head up display (HUD) image plane on which the image of the display device is focused to interfere with each other, and recording the wavefront on the HOE.

12. An HOE fabrication system for an HUD, the system comprising:
a master holographic optical element (HOE) on which an aberration caused by an optical system for projecting an image of a display device is recorded; and
a HOE configured to cause an aberrated wavefront of the optical system and a spherical wave to interfere with each other, and to record, the aberrated wavefront being reproduced by the master HOE which is reproduced on a display plane on which the image of the display device is expressed, the spherical wave being emitted from a head up display (HUD) image plane on which the image of the display device is focused.
